(19) United States
(12) Patent Application Publication
(10) Pub. No.: US 2009/0255427 A1
(43) Pub. Date: Oct. 15, 2009

(54) Hand-stamp with upper inking

(75) Inventor: Ernst Faber, Wels (AT)

Correspondence Address: COLLARD & ROE, P.C., 1077 NORTHERN BOULEVARD, ROSLYN, NY, 11576, US

(73) Assignee: Colop Stempelerzeugung Skopek Gesellschaft m.b.H. & Co. KG

(21) Appl. No.: 12/384,885

(22) Filed: Apr. 9, 2009

(30) Foreign Application Priority Data
Apr. 11, 2008 (AT) GM 210/2008

(51) Int. Cl. B41K 1/42

(52) U.S. Cl. 101/334

(57) ABSTRACT

A hand stamp with upper inking and comprising a housing displaceably accommodating an ink pad, an actuating part displaceably guided on the housing and pivotably supporting a character unit, which character unit includes at least one loop-shaped character band with stamp characters and is arranged within the housing and which, upon displacement of the actuating part against a spring force relative to the housing, is pivotable via a turning mechanism from an inking position, in which the character unit abuts on the ink pad, into a printing position. The hand stamp further comprises a stamp plate unit having an ink storage means and including a printing plate, wherein the stamp plate unit with ink storage means is combined with the character unit into a pivoting and displaceable unit, the printing side of the printing plate being arranged adjacent the stamp characters, and said the ink pad having an access opening restricted to the stamp characters of the character unit.

### FIELD OF THE INVENTION

The invention relates to a hand-stamp with upper inking and comprising a housing accommodating an ink pad, further comprising an actuating part displaceably guided on the housing and pivotably supporting a character unit, which character unit includes at least one loop-shaped character band with displaceable stamp characters and is arranged within the housing and which, upon displacement of the actuating part against a spring force relative to the housing, is pivotable via a turning mechanism from an inking position, in which the character unit abuts on the ink pad, into a printing position, as well as comprising a stamp plate unit with an ink storage means, said stamp plate unit including a printing plate.

### BACKGROUND OF THE INVENTION

From EP 0 258 323 B1, a hand stamp with upper inking is known, which comprises a character unit having character bands with displaceable stamp characters which are, e.g., designed for forming a date imprint. The character bands can be displaced by means of adjustment wheels. The character unit furthermore carries a fixed stamp plate which, when stamping, produces a fixed imprint independently of the displaceable characters. In this hand stamp, the printing block of the fixed stamp plate cannot be provided easily by the user but has to be previously applied to the stamp plate by the factory.

In WO 2007/082330 A1, a hand stamp is shown which comprises a printing plate which, by means of an actuating unit, can be brought from a position retracted in the housing into a printing position, against the spring force of a helical compression spring. The printing plate is partially open-porous and abuts on an ink storage member so as to receive stamping ink therefrom; the ink storage member is mounted in a retention means enclosing the storage member at least partially. A customer can mount the desired block himself by means of short-term exposure to light which causes a closing of the pores of the open-porous material in those regions, in which no stamp imprint is to be created; on the other hand, in those regions, in which a stamp imprint is to be created, the pores will remain open (so-called flash-type stamp plate). For this purpose, pre-cut plates, e.g. of ethylene-vinyl-acetate, are inserted in an exposure unit together with a film that comprises the desired stamp image to be imprinted. Thus, it will be very easy for customers to create by themselves any desired printing block. Yet, this stamp is not suitable for making imprints that change within a short period of time, such as the date. Thus, for such imprints, a character band unit having displaceable stamp characters (date bands) would be important. As such, it would be possible to build up also the band-provided characters of such a character band unit with an ink storage region, yet the total height of the characters, i.e. the dimensions by which the characters project from the band, would become so large that, in case of a combination with a non-changing text, a sufficiently large space must be provided for moving the character band with the characters, projecting on both sides, past said text.

WO 96/16817 A describes a stamping device of the type with upper inking and with a housing that has a stamping insert member which, in an upper inking position, receives ink from an ink pad and, via a turning mechanism, can reversibly be brought into a printing position. Furthermore, a receiving means for a pre-inked fixed stamp plate is provided on the lower side of the stamping device; the stamp plate has a passage opening for the—variable—characters of the stamp insert part. In order to keep this stamp plate at a distance from the stamp contact face during non-use, before the turning mechanism is actuated, lateral leaf springs are mounted on the lower side of the receiving means for the stamp plate, which leaf springs project beyond the stamp plate. In this case, it is difficult to create a uniform imprint of both stamp character types, it being necessary that the leaf springs be compressed, and because of the projecting leaf springs it will also be difficult to apply a protecting cap on the lower side of the stamping device.

It is now an object of the invention to provide a robust hand stamp with upper inking of the initially defined type, which has a simple construction and which, when using the movable character unit in combination with the fixed stamp unit, allows for obtaining uniform, consistent imprints, wherein, nevertheless, the use of pre-inked stamp plates or printing plates, respectively, shall be possible, since the latter are of advantage for the users in terms of designing their own images to be imprinted.

The hand stamp according to this invention, of the upper inking type as mentioned above, has a stamp plate unit, with an ink storage means, which is combined with the character unit to form a pivotable unit; the printing plate is, with its printing side, arranged next to the stamp characters of the character unit, and the ink pad is associated with an access opening, or has a size, respectively, that is restricted to the stamp characters of the character unit.

By this design, the afore-mentioned objects can well be met. The present design allows for a combination of the advantages of the system of upper inking with those of the system with ink storage means (so-called pre-inked stamp), without having to put up with the disadvantages of the known systems. The invention enables to combine a movable character unit having variable characters with an adaptable designing of a pre-inked stamp image to be imprinted, it being possible to obtain exact imprints of both types of stamp.

The hand stamp may be provided in two possible basic embodiments. In both cases, the stamp plate unit can be detachably connected to the (band) character unit, e.g. via screws. In the first embodiment, the customer can choose the ink before delivery. The stamp plate unit in-operation will then result from a stamp plate holder, a storage member (Filtrona), a printing plate and a retaining frame. In the second embodiment, the ink can freely be chosen by the customer at any time. For this purpose, the stamp plate unit in operation consists of a stamp plate holder, a retaining frame and a printing plate, which printing plate at the same time serves as storage member. In this embodiment, the bottom plate of the stamp plate holder has ink passage openings which serve for refilling the ink. In this case, the sum of the volumes of the ink passage openings or filling openings will exactly correspond to the volume of the deliberately selectable ink to be filled in. A separate inking frame which also has ink passage openings may be provided as an accessory for (re-)filling the ink and may be received by the stamp plate holder during filling.

On account of the comparatively larger dimensions of the retaining frame in the first embodiment, the hand stamp optionally has a slightly larger width and length than in the second embodiment.

For fastening to the third unit, the stamp plate holder may have lateral fastening legs which may, e.g., originate from the bottom plate that carries the printing plate, optionally inclusive of the storage member, as well as the retaining frame. If a printing plate and a storage plate are provided, it is suitable to configure the bottom plate trough-shaped, in which case the printing plate and the storage plate can be inserted in the trough-shaped bottom plate and fixed therein by means of the retaining frame. In case of a printing plate which at the same time functions as storage member, the bottom plate can carry the retaining frame which, in turn, accommodates the imprint storage plate.

As regards the arrangement of the members responsible for making the imprint, the stamp plate unit with ink storage means may be frame-shaped so that a frame opening will be defined in which, in the operating position, those stamp characters of the character unit will be present, which are respectively provided for making the imprint. As already mentioned, these stamp characters may be date characters or the like variable characters. At the (rear) side facing away from the printing side, a per-se known snap-on cover may be provided on the character unit. With the present hand stamp, the snap-on cover may be particularly advantageous insofar as also refilling of ink into the storage member of the stamp plate unit with pre-inking is conceivable in a manner that the stamp plate unit will be left within the stamp and ink will simply be refilled from the rear side, with a high likelihood of contacting the neighboring character unit. By this cover on the character unit, soiling of the fingers during refilling “in situ” will be prevented.

Finally, it is also particularly advantageous if the ink pad in terms of shape is restricted to the region of the stamp characters, allowing laterally a clear space for the printing plate when the character unit with the stamp plate unit including an ink storage means is in its inking position.

### BRIEF DESCRIPTION OF THE DRAWINGS

In the following, the invention will be further described with reference to particularly preferred exemplary embodiments illustrated in the drawings, to which embodiments, however, the invention shall not be restricted. In detail,

FIGS. 1A and 1B show perspective front and rear views of a hand stamp with upper inking in its inking position in accordance with a preferred embodiment of the invention;

FIG. 2 shows a longitudinal section through this hand stamp in the inking position of FIG. 1, according to line II-II of FIG. 3;

FIG. 3 shows a longitudinal section through this hand stamp in the inking position of FIG. 1, according to line III-III of FIG. 2;

FIG. 4 shows an exploded illustration of the components of a stamp plate unit with ink storage means in combination with a character unit of this hand stamp according to FIGS. 1 to 3;

FIG. 5 shows a perspective view of the combined stamp unit consisting of stamp plate unit and character unit, according to FIG. 4;

FIG. 6 shows a longitudinal section through this combined stamp unit according to line VI-VI of FIG. 5;

FIG. 7 shows a longitudinal section through the hand stamp of FIGS. 1 to 6, now in the printing position, according to line III-III in FIG. 2;

FIG. 8 shows a longitudinal section through a modified hand stamp in the inking position according to line VIII-VIII of FIG. 9;

FIG. 9 shows a longitudinal section through the hand stamp of FIG. 8 in the inking position, according to line IX-IX of FIG. 8;

FIG. 10 shows an exploded illustration of a stamp plate unit with an ink storage means and a character unit of this hand stamp according to FIGS. 8 and 9;

FIG. 11 shows a perspective exploded illustration of a printing plate and a retaining frame according to FIG. 10, in combination with an inking frame;

FIG. 12 shows a longitudinal section through a combined stamp unit similar to the illustration of FIG. 6; and

FIG. 13 shows a longitudinal section similar to FIG. 9 through the hand stamp according to FIG. 9, yet now in the printing position.

### DETAILED DESCRIPTION OF PREFERRED EMBODIMENTS

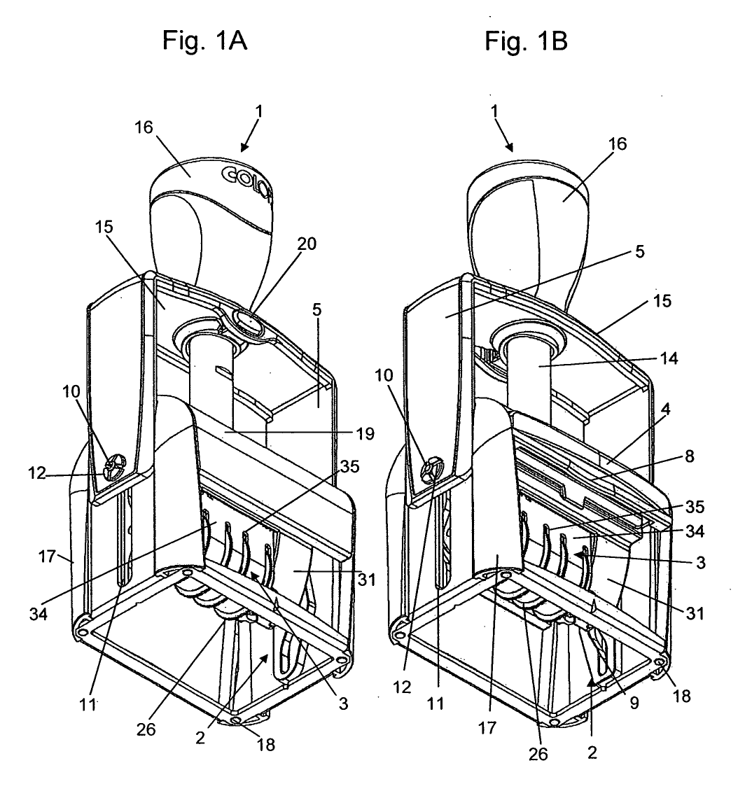

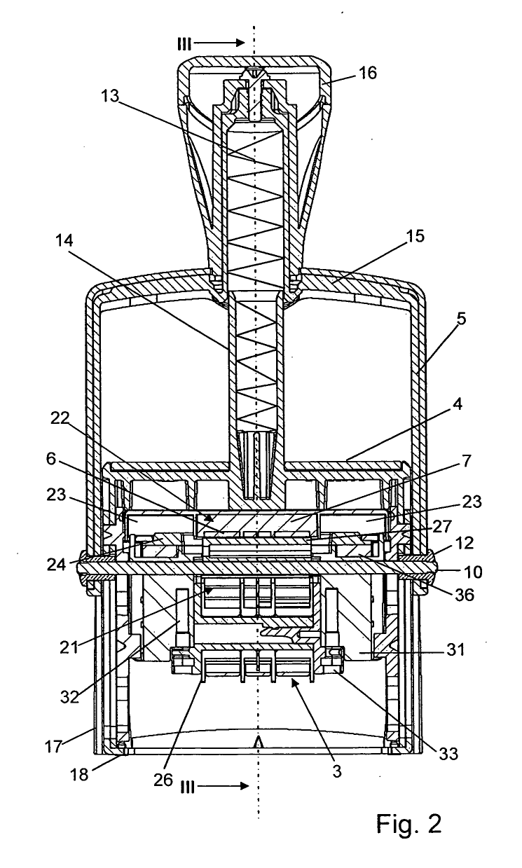

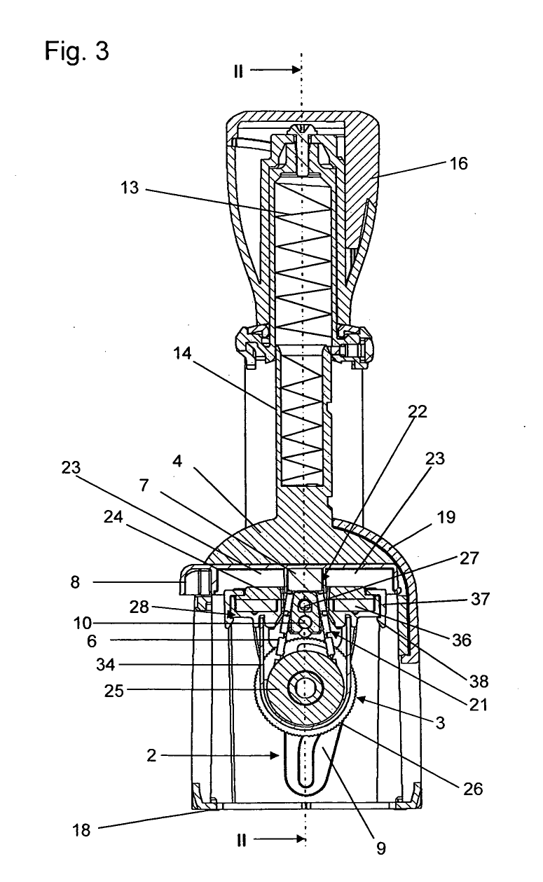

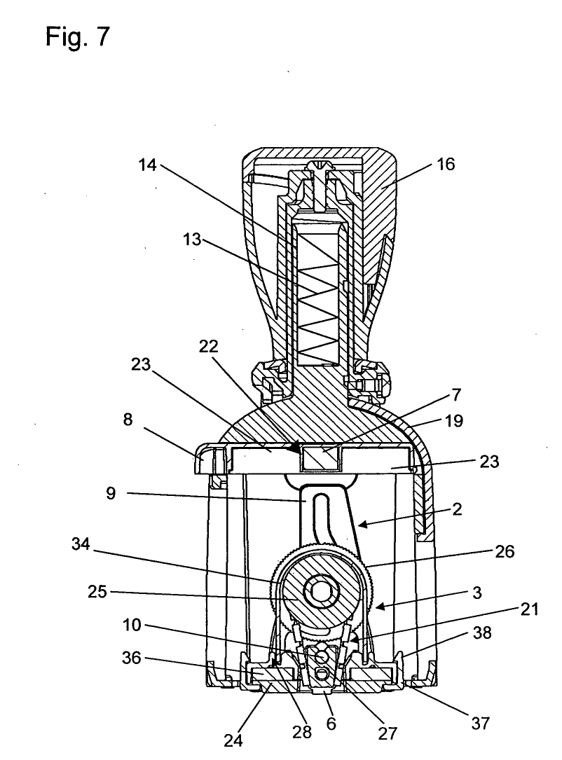

In FIGS. 1 to 3 as well as 7, a hand stamp 1 with upper inking comprising a turning mechanism 2 for a character unit 3 is shown in its inking position; the character unit 3 is movable up and down in a housing 4 by means of an actuating part 5 and, in doing so, is movable by 180° from an inking position illustrated in FIGS. 1 to 3, in which displaceable stamp characters 6 (not visible in FIG. 1, yet cf. FIGS. 2 and 3) abut on an ink pad 7 impregnated with stamping ink (not visible in FIG. 1, yet cf. FIGS. 2 and 3), into a lower, turned printing position (cf. FIG. 7). In the exemplary embodiment illustrated, the ink pad 7 is located in a drawer-like container 8 which can be pushed in and out, which container 8 is displaceably received by the housing 4. The turning mechanism 2 is of a construction known per se, cf. e.g. U.S. Pat. No. 1,401,436 A, and has turning parts 9 of wing-shaped design that are pivotably mounted on the upper end, and a turning axle 10. The turning axle 10 is connected to the stamp unit 3, extends through longitudinal slots 11 of the housing 4 and is fixed on the actuating part 5 by means of bushing-shaped axle-securing members 12.

The actuating part 5 is urged into the inking position by means of a spring 13 (cf. FIGS. 2 and 3) which rests on the upper side of the housing 4. The actuating part 5 is downwardly movable relative to the housing 4 against the spring force of the spring 13. The spring 13 is accommodated in a tubular member 14 which is attached to the housing 4 on the upper side thereof and extends into a hollow handle 16 mounted on the upper side of the bow-shaped actuating part 5 on a web 15 thereof, the-handle 16 and the tubular member 14 being telescopically moved within each other when the hand stamp 1 is actuated.

The housing 4 may be made of high quality steel, e.g., wherein plastics corner members 17 may be mounted in the corner regions; on the bottom side, anti-skid elements 18 made of plastics or of rubber are glued on. Due to their high friction, these anti-skid elements 18 prevent the housing 4 from slipping off, which is undesired, when the stamp is put onto a substrate.

A bow-shaped text inspection window 19 is furthermore applied to the housing 4. A push-button key 20 is mounted on the actuating part 5 and serves for fixing the actuating part 5 in pre-determined positions relative to the housing 4, as is known per se.

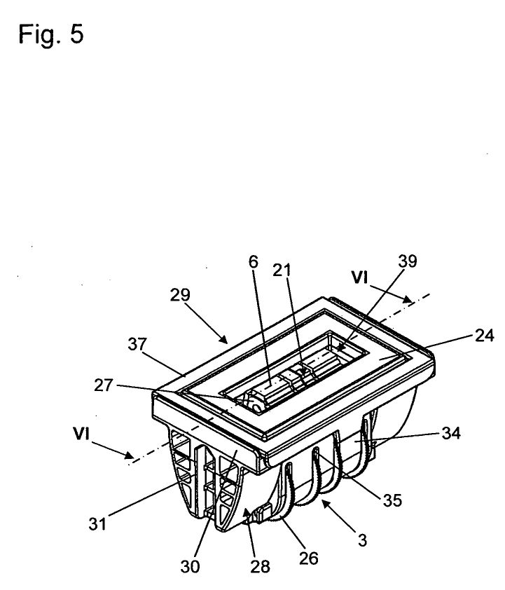

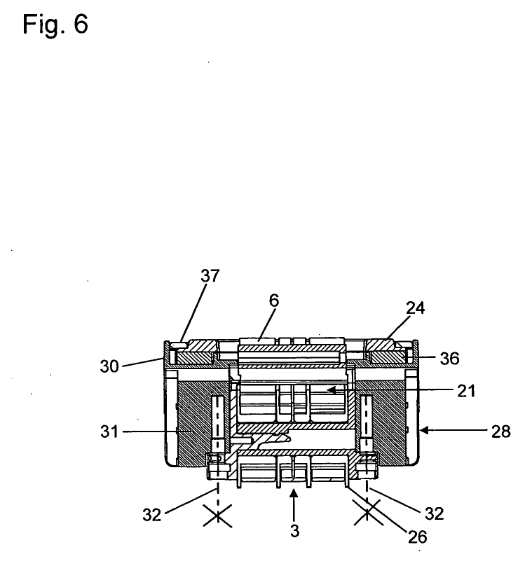

According to FIG. 2 and FIG. 3 (cf. also FIGS. 5 and 6), the character unit 3, which is arranged within the housing 4 and which, according to FIGS. 1 to 3, in its inking position contacts the ink pad 7, comprises at least one loop-shaped character band 21 with accordingly displaceable stamp characters 6. The ink pad 7, and its container 8, respectively, has an access opening 22 for these stamp characters 6 which is restricted to the dimension (or size) of the (area of the) stamp characters 6. Laterally, on either side of the restricted access opening 22 for the stamp characters 6, there are clearances 23 which serve for accommodating a previously inkable printing plate 24 of a separate stamp plate unit 29 and which make it possible for the printing plate 24 and the stamp characters 6 to be on the same level; this is primarily essential for the printing position shown in FIG. 7.

The at least one loop-shaped character band 21 is guided in a manner known per se over an adjustment wheel 26 rotatably mounted on a central body 25 of the character unit 3 and associated to the character band 21, and over a supporting ledge 27 supporting the respective stamp character 6 of the character band 21 intended for making an imprint. When shifting the actuating part 5 against the force of a spring 13 that acts within the telescopic tube arrangement 14-16 between the actuating part 5 and the housing 4, relative to the housing 4, the character unit 3 is transferred, in a conventional manner, by means of the turning mechanism 2, from the position shown in FIGS. 1 to 3, in which it abuts on the ink pad 7, into the printing position illustrated in FIG. 7, wherein also the printing plate 24 is co-pivoted and displaced.

As can be seen from FIGS. 2 to 7, the character unit 3 is connected to a stamp plate holder 28 of the stamp plate unit 29. The stamp plate holder 28 has a trough-shaped bottom plate 30 and laterally arranged fastening legs 31; via these fastening legs 31, it is displaceably fixed on the character unit 3 at its level relative to said character unit 3 by means of screws 32 schematically shown in FIG. 6. On its rear side, the character unit 3 has a hood-shaped character band cover 34 of U-shaped configuration, viewed in cross-section, which can be snapped on by means of snap-in elements 33. The cover 34 has slots 35 for the adjustment wheels 26. Details regarding the precise construction of such a character unit 3 with a cover 34 can be taken from AT 501 174 B1.

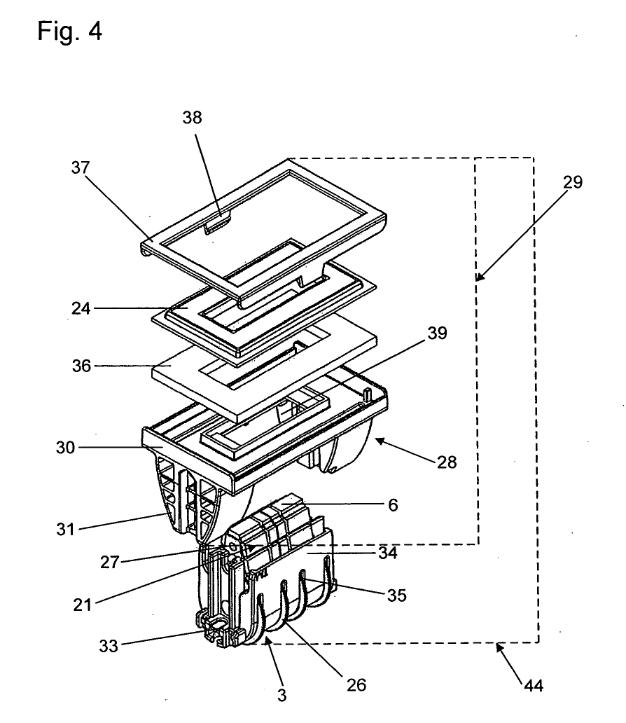

The stamp plate unit 29 with ink storage means is designed as can be seen in detail in FIGS. 4 and 5; it consists of the stamp plate holder 28, a storage member 36, the printing plate 24 and a retaining frame 37. For fixing the printing plate 24 on the holder 28, the retaining frame 37 includes latching hooks 38. The printing plate 24, the storage member 36, the retaining frame 37 and the bottom plate 30 of the stamp plate holder 28 have the shape of a frame, the stamp characters 6 of the character unit 3 being located in the opening 39 defined by this frame.

In FIG. 7, the hand stamp 1 is illustrated in its printing position. With the help of the turning mechanism 2, the character unit 3 and the stamp plate unit 29 have been brought into the printing position such that the displaceable stamp characters 6 and the printing plate 24 are located in one plane so that an exact, uniform imprint will be made. The tubular member 14 and the handle 16 are telescopically moved into each other. In the printing position, the stamp characters 6 and the printing plate 24 directly contact a substrate (paper, cardboard etc.) for making the stamp imprint.

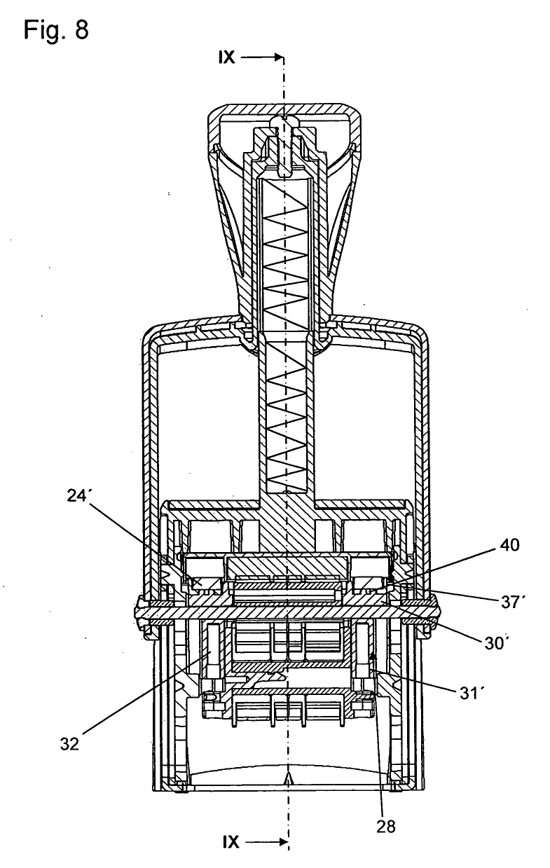

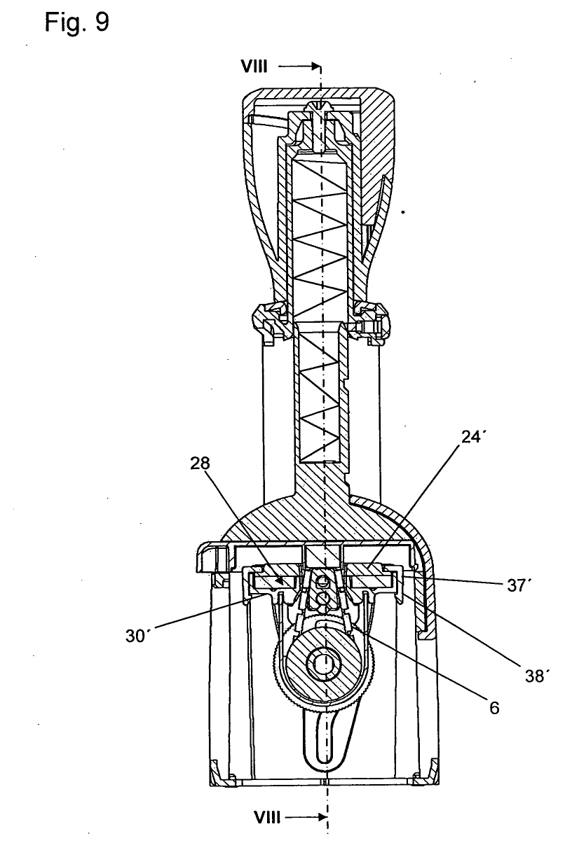

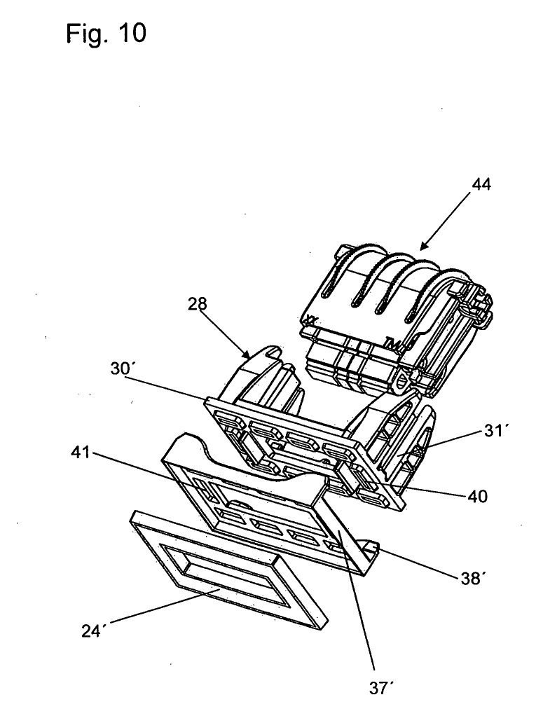

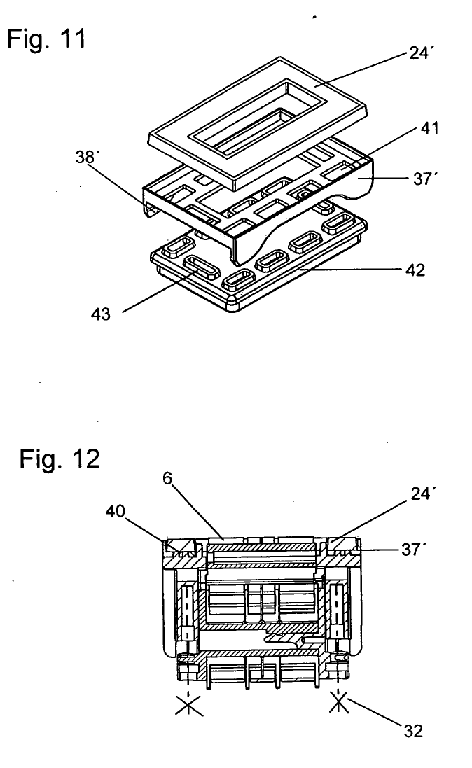

In FIGS. 8 to 13, a modified embodiment of the hand stamp 1 is shown, and the following description shall be restricted to the differences relative to the embodiment according to FIGS. 1 to 7; besides, reference is made to the previous embodiments.

Other than in FIGS. 1 to 7, the stamp plate holder 28 accommodates a porous printing plate 24′ which at the same time is designed as a storage member. The retaining frame 37′ is adapted accordingly, and the stamp plate holder 28 has a modified bottom plate 30′ as well as laterally arranged fastening legs 31′. The bottom plate 30′ and the retaining frame 37′ have ink passage openings 40, 41 serving for refilling ink. The sum of the volumes of the individual ink passage openings 40 of the bottom plate 30′ of the stamp plate holder 28 corresponds to the filling capacity of the printing plate 24′ with regard to the ink to be received. The retaining frame 37′ which accommodates the porous printing plate 24′ and retains it has four latching hooks 38′ each located at the corners, by means of which the retaining frame 37′ is fastened to the bottom plate 30′ in that the latching hooks 38′ snap in on the rim of the bottom plate 30′.

A separate inking frame 42 which likewise includes ink passage openings 43 is shown in FIG. 11, and this inking frame 42 may be enclosed when the hand stamp 1 is delivered or may be used for filling the printing plate 24′ with ink.

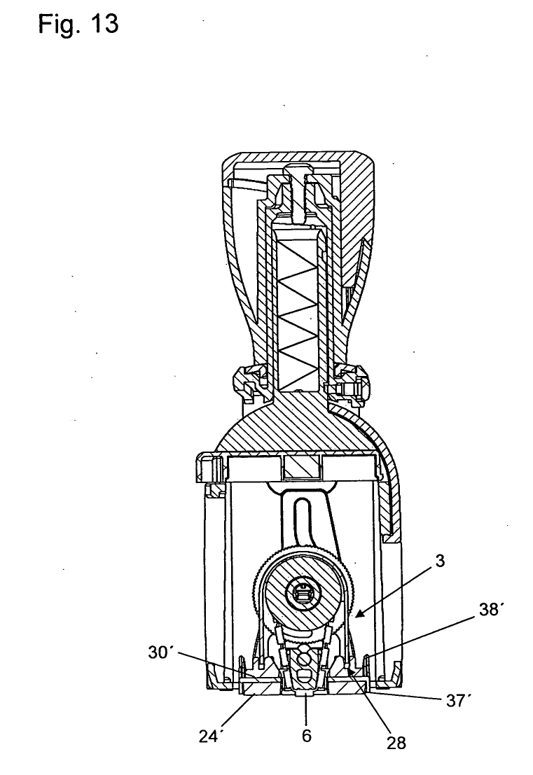

As in FIG. 7, in FIG. 13 the printing position of the hand stamp 1 according to FIG. 8 is shown. The character unit 3 and the stamp plate holder 28 have been shifted downwardly and pivoted, it again being visible that, in this printing position, the displaceable stamp characters 6 and the printing plate 24′ rest on the substrate (paper, cardboard etc.) at one and the same level.

1. A hand stamp with upper inking, comprising
a housing,
an ink pad received in said housing,
an actuating member displaceably guided on said housing,
a character unit pivotably supported on said actuating member and including at least one loopshaped character band having stamp characters, said character unit being arranged within said housing,
a turning mechanism, said character unit being pivotable by said turning mechanism from an inking position, in which the character unit abuts on said ink pad, into a printing position, upon shifting of said actuating member against a spring force relative to said housing, and
a stamp plate unit with ink storage means, said stamp plate unit including a printing plate and constituting, in combination with said character unit, a pivotable and displaceable unit, said printing plate having a printing side arranged adjacent said stamp characters of the character unit, and said ink pad having an associated access opening, or size, respectively, restricted to said, stamp characters of said character unit.

2. The hand stamp set forth in claim 1, wherein said stamp plate unit includes a stamp plate holder which accommodates said printing plate.

3. The hand stamp set forth in claim 2, wherein said stamp plate holder includes a bottom plate and lateral fastening legs originating from said bottom plates.

4. The hand stamp set forth in claim 3, wherein said bottom plate is trough-shaped so as to receive said printing plate.

5. The hand stamp set forth in claim 2, wherein said stamp plate holder is detachably connected to said character unit.

6. The hand stamp set forth in claim 5, further comprising screws connecting said stamp plate holder to said character unit.

7. The hand stamp set forth in claim 2, further comprising a retaining frame fixing said printing plate to said stamp plate holder.

8. The hand stamp set forth in claim 1, further comprising a separate ink storage member provided in abutment on said printing plate.

9. The hand stamp set forth in claim 3, wherein said bottom plate of said stamp plate holder includes ink passage openings.

10. The hand stamp set forth in claim 9, wherein said printing plate at the same time is configured as a storage plate and the ink passage openings are provided for refilling ink.

11. The hand stamp set forth in claim 10, further comprising a separate inking frame having passage openings and being associated to said printing plate.

12. The hand stamp set forth claim 1, wherein said printing plate has the shape of a frame defining an opening, said stamp characters of said character unit being located within said opening of said frame.

13. The hand stamp set forth in claim 3, wherein said stamp plate and said holding frame, said ink storing means and said bottom plate of said stamp plate holder have the shape of a frame defining an opening, said stamp characters of said character unit being located within said opening of said frame.

14. The hand stamp set forth in claim 1, wherein said stamp characters of said character unit are adjustable.

15. The hand stamp set forth in claim 14, wherein said adjustable stamp characters are adjustable date characters.

16. The hand stamp set forth in claim 1, wherein said character unit has a printing side and a side facing away from said printing side, further comprising a snap-on cover provided on said character unit on said side facing away from the printing side.

17. The hand stamp set forth in claim 1, wherein said ink pad has a shape restricted to a region occupied by said stamp characters, a lateral clear space being provided for said printing plate when said character unit with said stamp plate unit including said ink storage means is in its inking position.
